(19) United States
(12) Patent Application Publication
(10) Pub. No.: US 2005/0287495 A1
(43) Pub. Date: Dec. 29, 2005

(54) Dental appliance for weight management

(76) Inventor: William H. Longley, Atlanta, GA (US)

Correspondence Address: SMITH FROHWEIN TEMPEL GREENLEE BLAHA, LLC, P.O. BOX 88148, ATLANTA, GA, 30356, US

(21) Appl. No.: 10/859,828

(22) Filed: Jun. 3, 2004

(51) Int. Cl. A61C 5/00

(52) U.S. Cl. 433/140

(57) ABSTRACT

Various embodiments of dental appliances and methods are provided for managing weight loss. One embodiment is a dental appliance comprising: a palatal prosthetic having an upper surface disposed under the roof of the oral cavity and a lower surface that extends below the surface of the roof of the oral cavity for reducing the volume of the oral cavity; and means for orthodontically fixing the palatal prosthetic to a dental abutment.

### BACKGROUND

According to the American Obesity Association (AOA), obesity is a disease that affects nearly one-third of the adult American population (approximately 60 million). The number of overweight and obese Americans has continued to increase since 1960—a trend that is not slowing down. Research conducted by the AOA indicates that 64.5 percent of adult Americans (about 127 million) are currently categorized as being overweight or obese. Each year, obesity causes at least 300,000 excess deaths in the United States alone, and healthcare costs of American adults with obesity amount to approximately $100 billion.

Individuals with obesity are at risk of developing one or more serious medical conditions, which can cause poor health and premature death. For instance, scientific research suggests that obesity is statistically linked to adverse medical conditions, such as diabetes, coronary heart disease, high blood pressure, osteoarthritis, hypertension, cardiovascular disease, and various types of cancer, to a name a few of the more severe conditions. The problems associated with obesity and other less severe weight issues are not limited to medical conditions. Obese and overweight people may also suffer from a number of other problems (e.g., lifestyle problems, psychological conditions, social problems, etc.).

It is clear that obesity and other weight-related conditions are a severe problem for a large and ever-increasing number of people. Currently, there are a number of weight loss methods and devices for enabling people to attempt to manage their weight problems. The most prevalent methods include dieting, exercising, medications, body wrapping, surgical procedures, etc. Other weight management solutions involve mechanical devices and dental appliances. One such device is an elastic device that is attached over the mouth to inhibit, but not completely prevent food intake, and still permit normal breathing and speech, as disclosed in U.S. Pat. Nos. 4,825,881, 4,883,072 and 5,924,422. Another type of device is positioned in the mouth to stimulate salivation and swallowing, such as disclosed in U.S. Pat. Nos. 3,224,442 and 5,052,410.

Other dental devices are designed to be placed adjacent to or over the teeth, to impede chewing action and thus reduce food intake. For example, U.S. Pat. Nos. 4,727,867 and 4,738,259 describe examples of such devices. Another example is U.S. Pat. No. 4,471,771, which discloses a sieve-like device that is pivotally supported on upper teeth to block the intake of solid food when the mouth is opened.

U.S. Pat. No. 5,924,422 discloses a removable, retainer-like device that is molded to fit the contours and configuration of the user's mouth. The upper surface of the retainer-like device is configured to fit the roof of the user's mouth, while the lower surface is configured to replicate the roof, or palate, of the user's mouth. The retainer-like device is adapted to be easily and quickly put into use, without any special training, by positioning it in the mouth with the upper surface against the palate, and pushing the retainer between the corresponding teeth. When worn, the device effectively lowers the roof of the user's mouth to reduce the overall volume of the oral cavity. The device is intended to be easily inserted and removed by the user.

### SUMMARY

Various embodiments of dental appliances and methods are provided for managing weight loss. One embodiment is a dental appliance comprising a palatal prosthetic and a dental attachment for enabling a dental practitioner to securely fix the palatal prosthetic to a dental abutment. The palatal prosthetic has an upper surface to be disposed under the roof of the oral cavity and a lower surface that extends below the surface of the roof of the oral cavity for reducing the volume of the oral cavity.

Another embodiment of a dental appliance comprises: a palatal prosthetic having an upper surface disposed under the roof of the oral cavity and a lower surface that extends below the surface of the roof of the oral cavity for reducing the volume of the oral cavity; and means for orthodontically fixing the palatal prosthetic to a dental abutment.

Another embodiment is a weight loss method comprising: providing a palatal prosthetic to a patient, the palatal prosthetic having an upper surface disposed under the roof of the oral cavity, a lower surface that extends below the surface of the roof of the oral cavity for reducing the volume of the oral cavity, and a dental attachment; and securely fixing the palatal prosthetic in the mouth of the patient by fixing the dental attachment to a dental abutment.

### BRIEF DESCRIPTION OF THE DRAWINGS

Many aspects of the invention can be better understood with reference to the following drawings. The components in the drawings are not necessarily to scale, emphasis instead being placed upon clearly illustrating principles in accordance with exemplary embodiments of the present invention. Moreover, in the drawings, like reference numerals designate corresponding parts throughout the several views.

FIG. 1 is a side view of the head of a dental patient illustrating an embodiment of a dental appliance for weight management that is securely fixed within the mouth of the dental patient.

FIG. 2 is a perspective view of the dental appliance of FIG. 1.

FIG. 3 is a cross-sectional view of the dental appliance of FIG. 2 along lines 3-3.

FIG. 4 is a perspective view illustrating one embodiment of a mechanism for securely fixing the dental appliance of FIGS. 1-3 to a dental abutment.

FIG. 5 is a perspective view illustrating an additional embodiment of a mechanism for securely fixing the dental appliance of FIGS. 1-3 to a dental abutment.

FIG. 6 is a perspective view illustrating another embodiment of a mechanism for securely fixing the dental appliance of FIGS. 1-3 to a dental abutment.

FIG. 7 is a perspective view illustrating yet another embodiment of a mechanism for securely fixing the dental appliance of FIGS. 1-3 to a dental abutment.

FIG. 8 is a perspective view of an alternative embodiment of a dental appliance for weight management.

FIG. 9 is a cross-sectional view of the dental appliance of FIG. 8 along lines 5-5.

FIG. 10 is a perspective view of an additional embodiment of a dental appliance for weight management.

FIG. 11 is a cross-sectional view of the dental appliance of FIG. 10 along lines 7-7.

FIG. 12 is a perspective view of another embodiment of a dental appliance for weight management.

### DETAILED DESCRIPTION

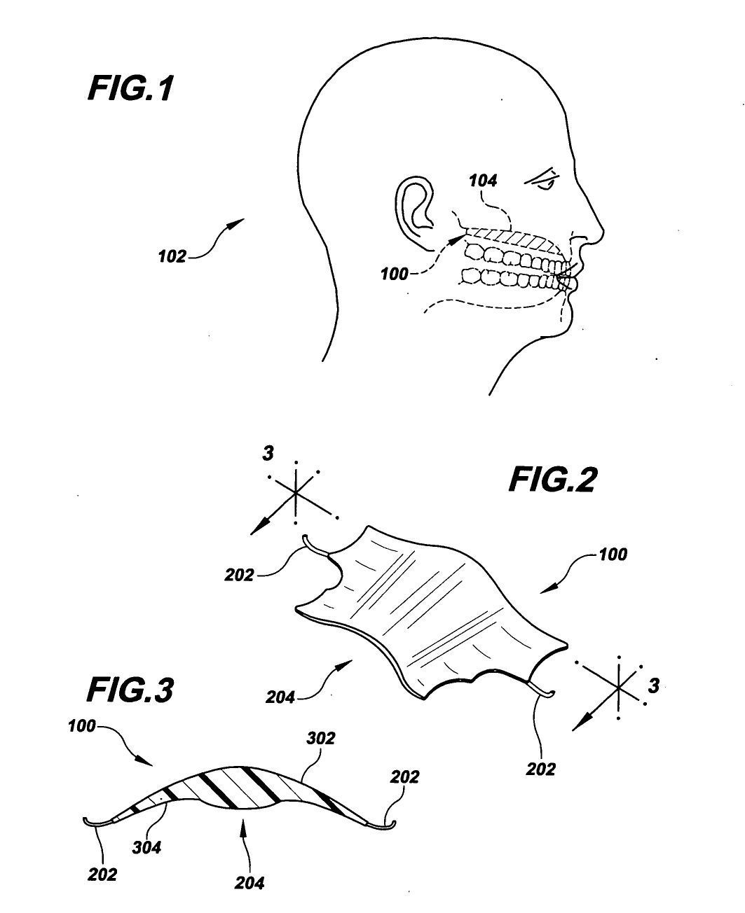

This disclosure relates to various embodiments of dental appliances and methods for enabling weight loss and/or managing an individual's body weight. Several embodiments are described below with respect to FIGS. 1-12. As an introductory matter, however, the basic structure and operation of an exemplary embodiment of a weight management dental appliance will be described.

In the exemplary embodiment, the weight management dental appliance comprises a palatal prosthetic that is securely fixed to a dental abutment (e.g., tooth, teeth, dental bracket, dental band, buccal tube, dental attachment, dental implant, etc.) by a dental practitioner. The dental practitioner may comprise a dentist, orthodontist, dental technician, medical doctor, periodontist, etc. or any individual providing medical and/or dental services. Because the palatal prosthetic is professionally installed and securely fixed within the patient's mouth, the weight management dental appliance may not be easily removed or uninstalled by the patient. In general, the palatal prosthetic has an upper surface to be disposed under the roof of the oral cavity of the patient. The lower surface of the palatal prosthetic extends below the surface of the roof of the oral cavity, thereby forming (as the name suggests) a palatal prosthetic. Due to the lower surface extending below the palate, the weight management dental appliance reduces the volume of the oral cavity. One of ordinary skill in the art will appreciate that, by reducing the volume of the oral cavity, the patient will consume smaller amounts of food per bite, which may reduce caloric intake and promote weight loss.

The weight management dental appliance may be securely fixed by a dental practitioner to any of a number of types of dental abutments (e.g., tooth, teeth, dental bracket, dental band, buccal tube, dental attachment, dental implant, etc.). For instance, the weight management dental appliance may include a dental attachment that enables the dental practitioner to securely fix the palatal prosthetic to the dental abutment. One of ordinary skill in the art will appreciate that, depending on the type of dental abutment being employed by the dental practitioner, the dental attachment may be configured in a variety of ways to be securely fixed to the dental abutment. For example, in one configuration, the dental abutment is a dental implant that is anchored to the bone (e.g., palate, jaw, etc.) of the patient. The dental attachment may be securely fixed to the bone-anchored dental implant. In a more simplistic configuration, the dental abutment is one or more dental brackets fixed to the patient's teeth, and the dental attachment includes one or more pieces of dental wire securely fixed to the dental bracket(s).

Various other types of dental attachments and/or dental abutments may be implemented. The configuration of the dental attachment and the dental abutment is not critical. Rather, the important aspect is that that the palatal prosthetic is professionally installed by a dental practitioner so that the dental attachment is orthodontically fixed to the dental abutment. In this manner, the weight management dental appliance may not be easily removed by the patient. Therefore, the weight management dental appliance may be used as a weight loss method for patients suffering from severe obesity, lack of self-discipline, etc. or for patients that otherwise cannot, or do not desire to, effectively use a removable dental appliance.

Having described the general structure and operation of an exemplary embodiment of a weight management dental appliance, several other embodiments will be described with respect to FIGS. 1-12. FIGS. 1-3 illustrate an embodiment of a weight management dental appliance 100, which may be securely fixed to a dental abutment by a dental practitioner. As best illustrated in FIG. 1 and briefly mentioned above, dental appliance 100 may be securely fixed within the mouth of a patient 102 so that the device is disposed under the patient's palate 104 and forms a palatal prosthetic. Referring to FIGS. 2 & 3, the palatal prosthetic includes a portion 204 that extends below palate 104 to reduce the volume of the oral cavity of patient 102.

As illustrated in the cross-sectional view of FIG. 3, the palatal prosthetic includes an upper surface 302 to be disposed under the patient's palate 104 during professional installation. In some embodiments, upper surface 302 (or portions thereof) may rest against the patient's palate 104. In other embodiments, upper surface 302 does not contact the patient's palate 104 but is securely and comfortably fixed under palate 104. The palatal prosthetic also includes a lower surface 304 which defines portion 204 that extends below palate 104 to define a prosthetic palate. Dental appliance 100 also comprises a dental attachment (e.g., dental wire 202—FIGS. 2 & 3) which may be used by the dental practitioner to securely fix the palatal prosthetic within the mouth of patient 102 as described above. It should be appreciated that the position, spatial orientation, etc. of dental wire 202 may be varied from that shown in FIGS. 2 & 3. Furthermore, additional dental attachments may be attached (e.g., integrally or otherwise) to dental wire 202. In alternative embodiments (some of which are described below), dental wire 202 may be replaced with a more suitable dental attachment(s) based on the particular orthodontic configuration. Nonetheless, in the embodiment illustrated in FIGS. 2 & 3, dental wire 202 extends from the lateral sides of dental appliance 100.

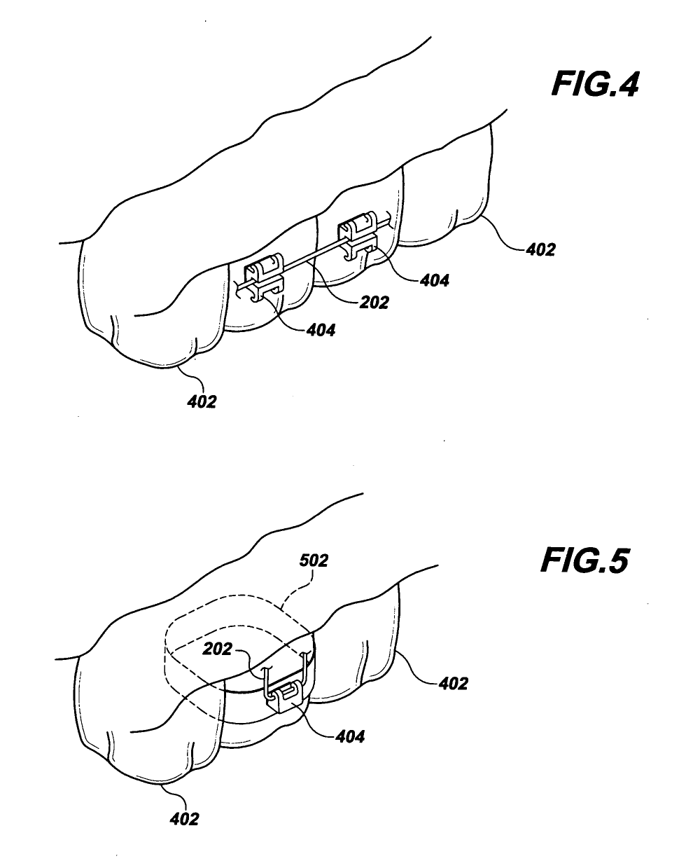

FIG. 4 illustrates one of a number of embodiments of a mechanism for securely fixing the dental attachment of the dental appliance of FIGS. 1-3 to a dental abutment. As illustrated in the embodiment of FIG. 4, the dental abutment may comprise one or more dental brackets 404 attached to teeth 402 of the patient 102. Bracket(s) 404 may be joined to teeth 402 in a number of ways. For example, in one embodiment, the dental practitioner may bond bracket(s) 404 to teeth 402 using an adhesive. In alternative embodiments, such as illustrated in FIG. 5, bracket(s) 404 may be attached (e.g., welded, bonded, integrally formed, etc.) to a dental band 502. As known in the art, dental band 502 may be disposed around a tooth 402 to provide additional support. Furthermore, depending on the particular dental scenario for each patient 102, additional dental mechanisms (e.g., spacers, buccal tube(s), frames, connecting bars, etc.) may be employed to install dental band 502, bracket(s) 404, dental wire 202, etc.

Although only a portion of the patient's teeth 402 are illustrated in FIGS. 4 and 5, it should be appreciated that bracket(s) 404 may be joined to teeth 402 on both sides of the mouth to provide a suitable support structure for securely fixing the dental attachment(s). For example, in embodiments where dental wire 202 is provided on the lateral sides of dental appliance 100 (FIGS. 2 and 3), bracket(s) 404 may be joined on teeth 402 on both sides of the patient's mouth. In this manner, as illustrated in FIGS. 4 and 5, the dental practitioner may securely fix dental appliance 100 by inserting dental wire 202 into the recess defined by the bracket and engaging the clipping mechanism.

Again, it should be appreciated that the spatial orientation, location, etc. of the dental attachment(s) (e.g., dental wire 202) on dental appliance 100 may vary. In this regard, one of ordinary skill in the art will appreciate that a variety of orthodontic practices may be employed to securely fix dental appliance 100 to a dental abutment in the patient's mouth. For example, the dental attachment may be joined directly to a tooth 402 without any additional dental abutment(s). Therefore, in this particular embodiment, tooth 402 may function as the actual dental abutment.

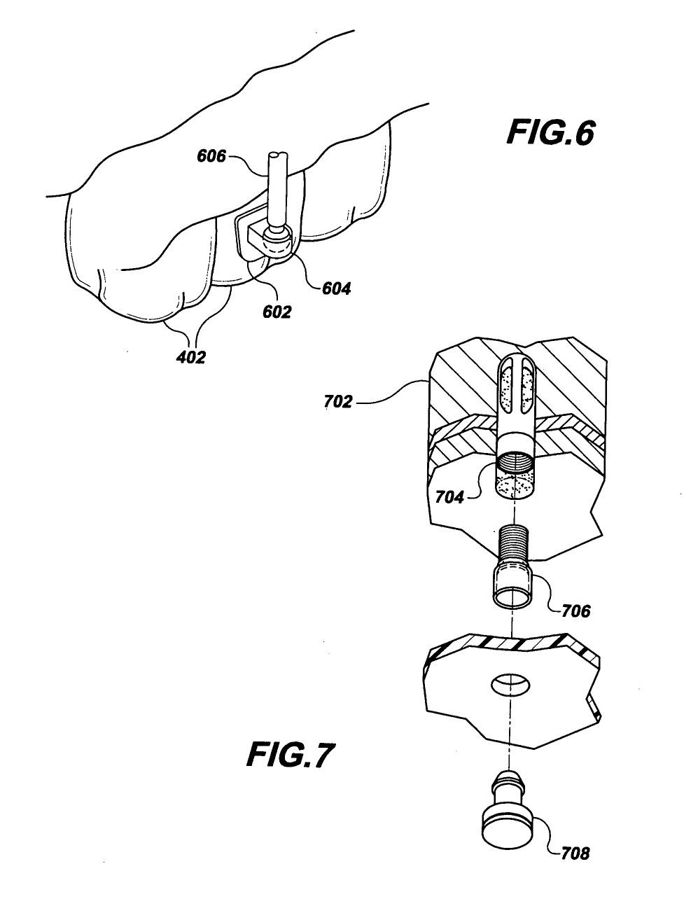

FIG. 6 illustrates another embodiment of a mechanical configuration for securely fixing dental appliance 100 within the patient's mouth. As illustrated in FIG. 6, one or more male attachment pieces 606 may be joined to dental appliance 100 (e.g., welded, glued, bonded, integrally formed, etc.). The male attachment pieces 606 may be positioned on upper surface 302, lower surface 304, or any other suitable location on dental appliance 100. Corresponding female piece(s) 604 may be joined to one or more teeth 402 via, for example, a support piece 602 that is bonded, glued, etc. to teeth 402. Support piece 602 and female piece(s) 604 may be integrally formed or joined in any suitable manner. Female piece(s) 604 and male piece(s) 606 are preferably configured so that the mechanical connection between the pieces provides a secure fit. For example, in one embodiment, pieces 604 and 606 comprise extracoronal castable attachments. One of ordinary skill in the art will appreciate that additional components may also be employed.

During the installation procedure, the dental practitioner may securely fix dental appliance 100 by engaging pieces 604 and 606 (FIG. 6). In some embodiments, it may be advantageous to configure pieces 604 and 606 in such a way that they can only be mechanically connected with the aid of a dental tool. This additional feature may deter patients 102 from attempting to remove dental appliance 100 once it has been installed by the dental practitioner.

FIG. 7 illustrates an alternative embodiment of an orthodontic configuration for securely fixing dental appliance 100 within the patient's mouth. In this embodiment, the dental practitioner first anchors a dental implant 704 to a bone (e.g., jaw, palate 104, etc.) in the patient's mouth. A suitable dental attachment (e.g., attachments 706 and 708) may be provided on dental appliance 100. The dental attachment may be integrally formed with dental appliance 100 or connected to (or otherwise joined to) dental appliance 100. As mentioned above with respect to the embodiment of FIG. 3, the spatial orientation, location, etc. of the dental attachment on dental appliance 100 may also vary.

Referring to FIG. 7, either of attachments 706 and 708 may be provided with dental appliance 100. During the installation process, after dental implant 704 is anchored to the bone, dental appliance 100 may be securely fixed to dental implant 704 by engaging the dental attachment on dental appliance 100 with dental implant 704. It should be appreciated that a number of alternative types of dental attachments may be employed for the engagement with dental implant 704.

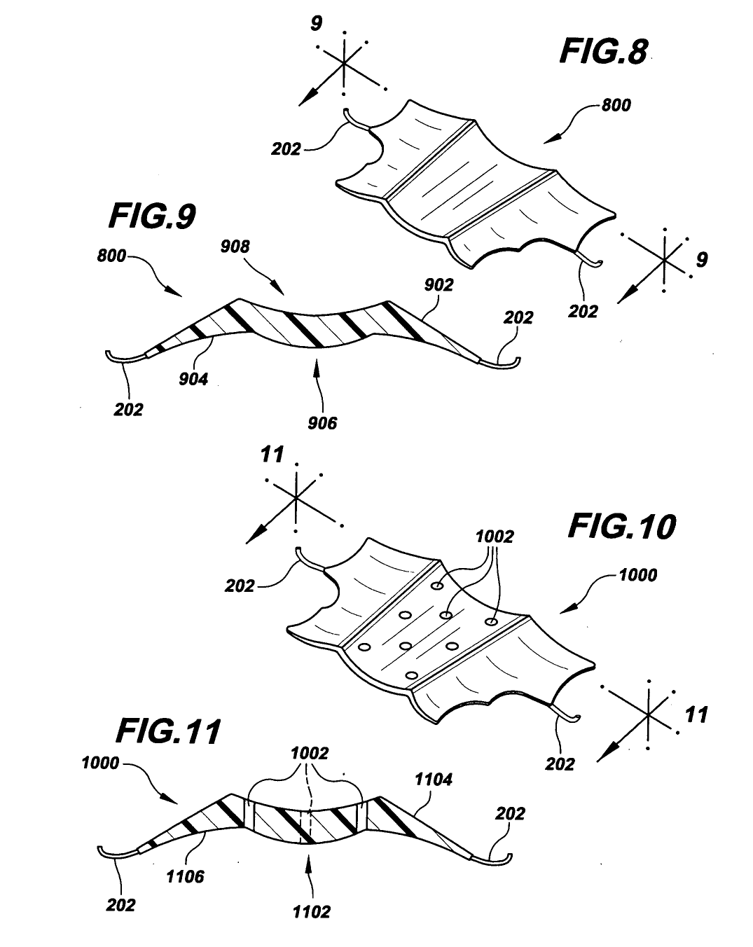

FIGS. 8 and 9 illustrate an alternative embodiment of a dental appliance 800 for weight management. Dental appliance 800 may include any of the dental attachments described above relative to dental appliance 100. Furthermore, dental appliance 800 may be configured to be securely fixed to any of the corresponding dental abutments described above using any orthodontic configuration.

Dental appliance 800 may be securely fixed within the mouth of a patient 102 so that the device is disposed under the patient's palate 104 and forms a palatal prosthetic. The palatal prosthetic includes a portion 906 that extends below palate 104 to reduce the volume of the oral cavity of patient 102. The palatal prosthetic includes an upper surface 902 to be disposed under the patient's palate 104 during professional installation. As best illustrated in the cross-sectional view of FIG. 9, upper surface 902 includes a concave surface that forms a recess 908 between palate 104 and the palatal prosthetic. It should be appreciated that recess 908 may enable patient 102 to more easily flush out any debris that may accumulate between dental appliance 800 and palate 104.

FIGS. 10 and 11 illustrate a further embodiment of a dental appliance 1000 for weight management. Dental appliance 1000 may be configured in much the same manner as dental appliance 100 and/or dental appliance 800. Dental appliance 1000 includes one or more holes 1002 that extend through the palatal prosthetic. Similar to recess 908 (FIG. 9), holes 1002 may promote the flushing out of debris that may accumulate between dental appliance 1000 and palate 104. It should be appreciated that hole(s) 1002 may be positioned in any suitable location, arrangement, etc. on the palatal prosthetic.

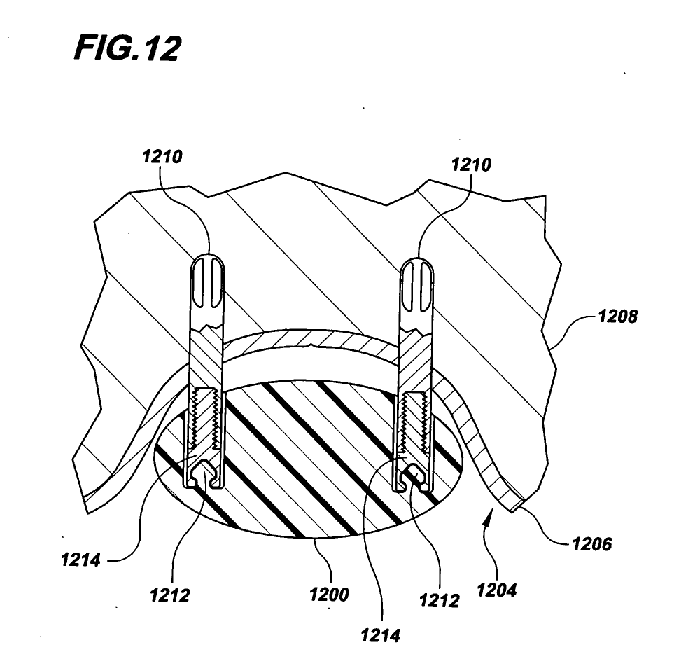

It should be further appreciated that the size and shape of the palatal prosthetic may be modified in any suitable manner. For example, in the alternative embodiment illustrated in FIG. 12, a dental appliance 1200 forms an elliptical-shaped cross-section. In this manner, dental appliance 1200 may be conveniently disposed below the roof 1204 of the oral cavity to form the palatal prosthetic. Of course, the dimensions of the palatal prosthetic may be further modified in any suitable manner depending on a number of factors, including the particular physical dimensions of the dental patient, as well as the particular means by which the palatal prosthetic is securely fixed.

As described above and further illustrated in FIG. 12, dental implant(s) 1210 may be professionally installed through tissue 1206 in the roof 1204 of the oral cavity and anchored to the palate 1208 of the dental patient. Dental appliance 1200 may include one or more dental attachments 1212 which may be securely fixed to the corresponding dental implant 1212 by any suitable mechanical engagement (e.g., male-to-female, etc.). In this manner, dental appliance 1200 may be securely fixed below the roof 1204 of the oral cavity to form the palatal prosthetic. As further illustrated in FIG. 12, dental implant(s) 1210 may include an adjustment mechanism 1214 that enables the dental practitioner to adjust the vertical displacement of dental attachment(s) 1212 and, therefore, the displacement of dental appliance 1200 relative to roof 1204.

1. A dental appliance comprising:
a palatal prosthetic having an upper surface disposed under the roof of the oral cavity and a lower surface that extends below the surface of the roof of the oral cavity for reducing the volume of the oral cavity; and
a dental attachment for enabling a dental practitioner to securely fix the palatal prosthetic to a dental abutment.

2. The dental appliance of claim 1, wherein the dental attachment is integrally formed with the palatal prosthetic.

3. The dental appliance of claim 1, wherein the dental abutment comprises a dental implant.

4. The dental appliance of claim 1, wherein the dental abutment comprises a tooth.

5. The dental appliance of claim 1, wherein the dental abutment comprises a bracket attached to a tooth.

6. The dental appliance of claim 1, wherein the dental abutment comprises a dental band secured to a tooth.

7. The dental appliance of claim 1, wherein the upper surface of the palatal prosthetic includes a concave surface that forms a recess between the roof of the oral cavity and the palatal prosthetic.

8. The dental appliance of claim 1, wherein the dental abutment comprises a dental implant including one of a female element and a male element and the dental attachment comprises the other of the female element and the male element for enabling the dental practitioner to securely mate the male and female elements.

9. A weight loss method comprising:
providing a palatal prosthetic to a patient, the palatal prosthetic having an upper surface disposed under the roof of the oral cavity, a lower surface that extends below the surface of the roof of the oral cavity for reducing the volume of the oral cavity, and a dental attachment; and
securely fixing the palatal prosthetic in the mouth of the patient by engaging the dental attachment to a dental abutment.

10. The weight loss method of claim 9, wherein the dental attachment comprises dental wire and wherein the securely fixing the palatal prosthetic comprises integrally fixing the dental wire to a bracket bonded to a tooth.

11. The weight loss method of claim 9, wherein the dental attachment comprises dental wire and wherein the securely fixing the palatal prosthetic comprises welding the dental wire to a dental band.

12. The weight loss method of claim 9, wherein the dental attachment comprises dental wire and wherein the securely fixing the palatal prosthetic comprises bonding the dental wire to a tooth.

13. The weight loss method of claim 9, wherein the upper surface of the palatal prosthetic includes a concave surface that forms a recess between the roof of the oral cavity and the palatal prosthetic.

14. The weight loss method of claim 13, further comprising:
inserting a dental implant; and
securely fixing the dental attachment to the dental implant.

15. The weight loss method of claim 9, wherein the securely fixing the palatal prosthetic comprises attaching the palatal prosthetic to a bracket on at least one tooth.

16. The weight loss method of claim 9, wherein the securely fixing the palatal prosthetic comprises attaching the dental attachment to a dental implant.

17. The weight loss method of claim 9, wherein the securely fixing the palatal prosthetic comprises attaching the dental attachment to a tooth.

18. The weight loss method of claim 9, wherein the securely fixing the palatal prosthetic comprises securely engaging the dental attachment with a dental implant.

19. The weight loss method of claim 18, wherein the securely engaging the dental attachment with the dental implant involves a male-to-female mechanical engagement.

20. A dental appliance comprising:
a palatal prosthetic having an upper surface disposed under the roof of the oral cavity and a lower surface that extends below the surface of the roof of the oral cavity for reducing the volume of the oral cavity; and
means for orthodontically fixing the palatal prosthetic to a dental abutment.
